(19) United States
(12) Patent Application Publication
(10) Pub. No.: US 2014/0058794 A1
(43) Pub. Date: Feb. 27, 2014

(54) Method And System For Orders Planning And Optimization With Applications To Food Consumer Products Industry

(71) Applicants: Denis Malov, Scottsdale, AZ (US); Gustavo Ayres De Castro, Scottsdale, AZ (US)

(72) Inventors: Denis Malov, Scottsdale, AZ (US); Gustavo Ayres De Castro, Scottsdale, AZ (US)

(73) Assignee: SAP AG, Walldorf (DE)

(21) Appl. No.: 13/595,625

(22) Filed: Aug. 27, 2012

(51) Int. Cl. G06Q 30/02; G06Q 10/08

(52) U.S. Cl. 705/7.31

(57) ABSTRACT

A system, a computer program product, and a method for order planning and optimization are disclosed. A first data is received, where the first data represents historical shipment data of an item from a distributor to a location. The received first data is processed and a model for at least one shipping pattern of the item from the distributor to the location is determined based on the processed received first data. A forecast for a future shipping demand of the item by the location is generated based on the determined model. At least one shipping pattern of the item from the distributor to the location is optimized based on the generated forecast.

### TECHNICAL FIELD

This disclosure relates generally to data processing and, in particular, to order planning and optimization.

### BACKGROUND

Among some of the biggest challenges and goals for consumer products (e.g., food) companies on supply chain side of the business is creating a system capable of “perfect” supply replenishment order. A “perfect” order can be an order that fulfills a demand for the product and produces no waste or returns. The complexity of this system can be easily understood from the everyday grocery shopping experiences. On one hand, consumers or shoppers can face out-of-stock events when an in-demand product is not available on the shelf. On the other hand, food items might expire while on the shelf, thereby producing waste and/or returns. A “perfect” order or a shipment of a food item would have to fit exactly the demand for product in between shipments. For example, if shipments are done on a weekly basis, then for each week it might be preferable to ship a number or a quantity of a product that is anticipated to be sold during the week.

This is a typical challenge for producers of meat/poultry products, bread, fresh produce, milk etc. as these items have a well-defined and short shelf life. Standard supply chain planning and forecasting systems available on a market from various vendors typically operate on very high level of distribution centers for demand approximation and fulfillment of the shipments. In such conventional approach, company's focus can be on accounting for available items at distribution center locations' inventory levels with little understanding of local demand variations for the products it produces. Due to this shortcoming, product returns and/or waste can reach significant percentage of the overall production and revenues. Further complications can arise when freshly produced products are shipped to store locations daily (and/or sub-daily (e.g., a portion of a day), hourly, for a predetermined period of time, and/or on any other basis and/or any combination thereof) with little or no extra inventory available to cover for the local shortages. An example of that is bread production: bread is produced and distributed daily (and/or sub-daily (e.g., a portion of a day), hourly, for a predetermined period of time, and/or on any other basis and/or any combination thereof). If under-produced, revenue can be lost due to unrealized unit sales. If over-produced, waste can occur through returns of expired bread. As typical in this business scenario, producers can try to create and maintain safety stock of the products at store location to minimize for shortage and take better control over demand variations. Unfortunately standard rules around safety stock lack basic understanding of local demand and their variations. Also, absence of integration points between supply chain of product producers and inventory management systems of the grocery chains can result in loss of visibility to inventory levels. Effectively producers are trying to maintain safety stock without reliable information on current inventory levels which is extremely ambiguous and error-prone.

### SUMMARY

In some implementations, the current subject matter relates to a computer-implemented method for order planning and optimization. A first data can be received. The first data can represent historical shipment data of an item from a distributor to a location. The received first data can be processed and a model for at least one shipping pattern of the item from the distributor to the location can be determined based on the processed received first data. A forecast for a future shipping demand of the item by the location can be generated based on the determined model. At least one shipping pattern of the item from the distributor to the location can be optimized based on the generated forecast. At least one of the receiving, the processing, the determining, the generating, and the optimizing can be performed on at least one processor.

In some implementations, the current subject matter can include one or more of the following optional features. The first data can include at least one of the following: a foot traffic at the location, a historical point-of-sale data of the item, including promotional activities, an inventory of the item at the location, a competitor of the location information with regard to the item, a return data representing returns of the item from the location, at least one calendar at the location, and at least one business rule concerning shipment of the item from the distributor to the location.

Models can be determined based on the above mentioned data and allow the creation of estimates of at least one of the following: price sensitivity of the item at the location, promotional effect with regard to the item as determined at the location, a seasonality of the item at the location, age of the item at the location, customer purchasing pattern with regard to the item, age of the returned items from the location, and a substitution policy of the item at the location.

The forecast can be generated for a predetermined period of time.

The optimizing of at least one shipping pattern of the item further can include optimizing the at least one shipping pattern based on at least one unforeseen event.

The future shipping demand can be determined based on a simulation of at least one sale of the item at the location. The method can also include determining, based on the simulation, a starting date for shipping of the item to the location.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for order planning and optimization, according to some implementations of the current subject matter;

FIG. 2 illustrates another exemplary system for order planning and optimization, according to some implementations of the current subject matter;

FIG. 3 illustrates an exemplary system where system for order planning and optimization can be implemented, according to some implementations of the current subject matter;

FIG. 4 illustrates an exemplary order optimization plot, according to some implementations of the current subject matter;

FIG. 5 illustrates an exemplary process for order planning and estimation, according to some implementations of the current subject matter;

FIG. 6 illustrates further exemplary system for order planning and optimization, according to some implementations of the current subject matter;

FIG. 7 is a diagram illustrating an exemplary system including a data storage application, according to some implementations of the current subject matter;

FIG. 8 is a diagram illustrating details of the system of FIG. 7;

FIG. 9 illustrates an exemplary system, according to some implementations of the current subject matter; and

FIG. 10 illustrates an exemplary method, according to some implementations of the current subject matter.

### DETAILED DESCRIPTION

To address the above-noted and potentially other deficiencies of currently available solutions, one or more implementations of the current subject matter provide methods, systems, articles or manufacture, and the like that can, among other possible advantages, provide systems and methods for providing systems, methods, and computer program products for order planning and optimization.

In some implementations, the current subject matter system can be used for planning and optimization of orders that can be used in determining production of items in a consumer product industry. In some implementations, the items can include at least one of the following: consumer products, perishable products, technology products, food products, food-related products, products having an expiration date (e.g., a date beyond which it might not be recommended to consumer and/or use the item), as well as any other products.

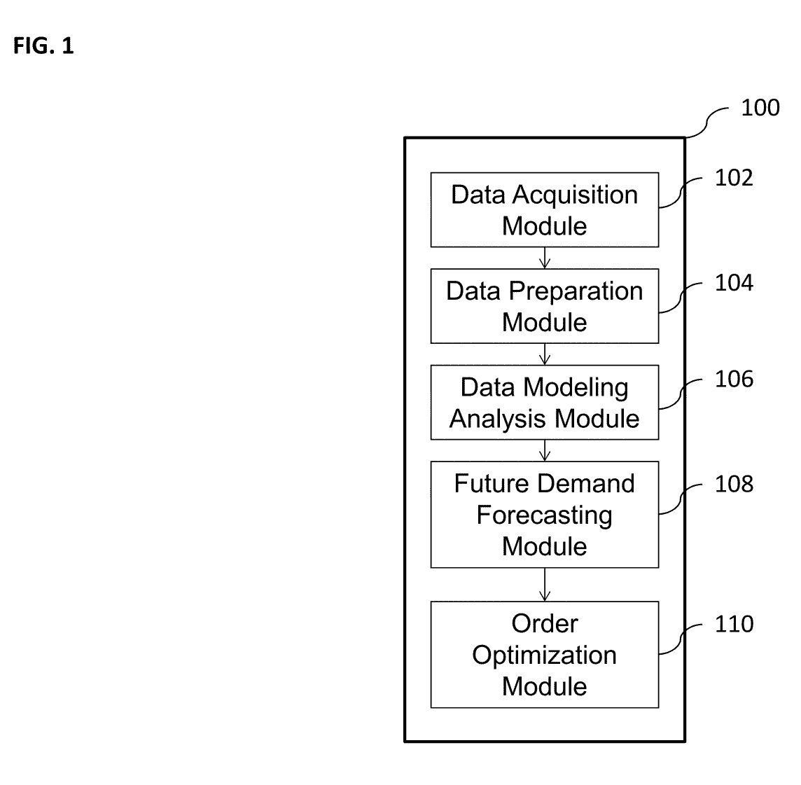

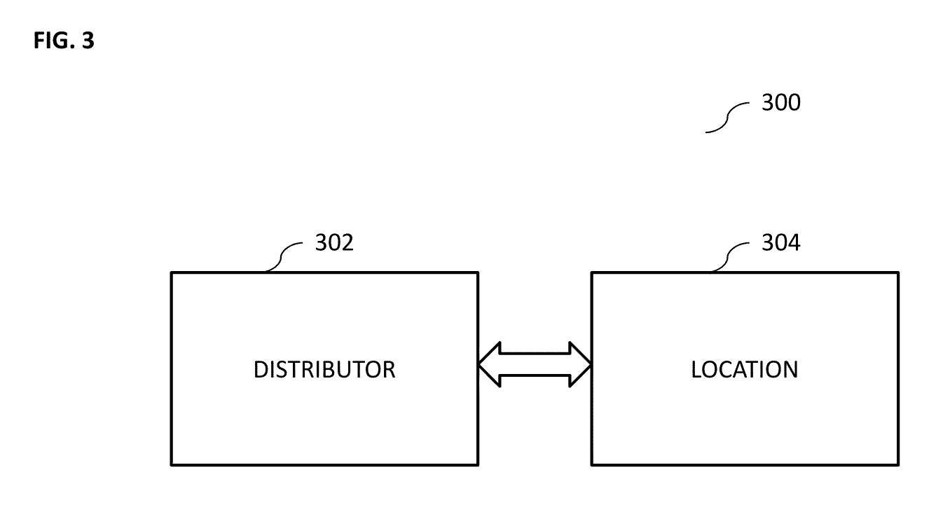

FIG. 1 illustrates an exemplary system 100 for order planning and optimization, according to some implementations of the current subject matter. The system 100 can include a data acquisition module 102, a data preparation module 104, a data modeling analysis (e.g., data mining and modeling) module 106, a future demand forecasting module 108, and an order optimization module 110. The system 100 can be implemented for planning and/or optimization of item shipment orders. For example, such items can be various food items and such system can be implemented to accommodate order planning and optimization for a grocery store that is selling such food items. The system 100 can substantially minimize return and/or waste of items that are shipped and can reduce instances of a lack of inventory at the store. The system can further minimize waste and maximize revenue through modeling and forecasting of historical demand on product-store level, optimize orders that utilize forecasted demand and demand uncertainty as well as information on most current shipments, returns, and unit sales, optimize orders in a reliable and stable fashion within business scenarios with high uncertainty around values of current and historical inventory levels, provide modeling and forecasting safety stock levels on product-store level based on modeling of historical volatility, and allow for “what-if scenarios (e.g., weather variations (e.g., unseasonably cold, hot, rainy, snowy, etc.), future promotion tactic(s) combination(s), future pricing schedules, extreme events (e.g., natural disasters, man-made disasters, wars, etc.), and/or any other events (whether known or unforeseen), etc.) and planning exercises within broad class of optimization functions taking into account various trade-offs between financial impacts of lost sales and product waste. As shown in FIG. 3, the system 100 can be implemented in a system 300 that can include a distributor 302 and a location 304, where the location 304 can be a grocery store and/or any other type of retail location that sells items received from the distributor 302. The distributor 302 can be a manufacturer of such items, a distributor receiving items from the manufacturer of items, a distributor receiving items from another distributor, etc. In some implementations, the location 304 can be a manufacturer of items, a distributor of items, and/or any other location.

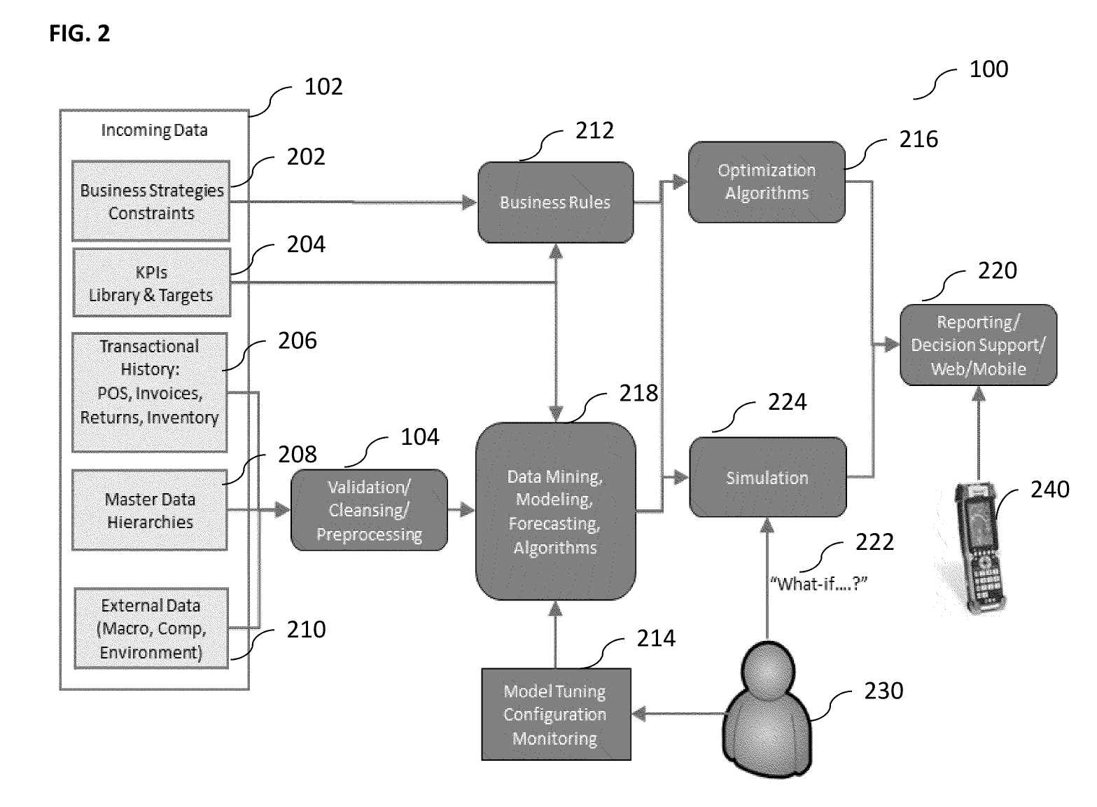

FIG. 2 illustrates further details of the system 100 for order planning and optimization shown in FIG. 1, according to some implementations of the current subject matter. The data acquisition module 102 can receive various incoming and/or input data for processing by the system 100. The data can include business strategies constraints 202, key performance indicators (“KPI”) library and target data 204, transaction history data 206 (e.g., point-of-sale information, invoices, returns of items, item inventory, etc.), master data hierarchies 208, and external data 210.

In some implementations, the transaction history data 206 can include historical point-of-sale data for a predetermined period of time (e.g., including two years worth of information on unit sales on a product-store level). It can also include inventory information, such as how many items of a particular kind remain at the location (e.g., store, distribution facility, etc.), what their expiration date is, price information, etc. The data 206 can also include data describing historical shipments and returns data along with matching point-of-sale history. This data can indicate when items have been shipped to a location, how many items were shipped to the location, how many items have been returned from the location, when such items have been returned, a frequency of return for a particular item from the location, a frequency of shipment of a particular item to the location, etc.

The external data 210 can include econometric and/or market data. The data can include information related to econometric indices influential to demand such as competitive and/or benchmarking pricing information that can potentially improve performance of statistical models. The business strategies constraints 202 and KPI library and target data 204 can include rules of the business processes related to supply chain, production, and customer relationship management (“CRM”) data as well as financial measures that can be used in optimization processes.

The data preparation module 104 can perform data validation, cleansing, mapping, and/or aggregation. Input data that is received by the data acquisition module 102 can be mapped and prepared and/or pre-processed for the purposes of modeling of data. Data aggregation can be driven by statistically defined modeling elements such as clusters or modeling aggregates that can allow for best statistical inference of information. The data preparation module 104 can receive the transaction history data 206 (e.g., point-of-sale information, invoices, returns of items, item inventory, etc.), master data hierarchies 208, and external data 210. Once the data is processed by the data preparation module 104, the data can be provided to the data modeling module 106. The data modeling module 106 can perform statistical modeling designed for modeling a historical demand. It can take into account at least one of the following variables: variations in price, seasonal and/or special events, weather, current demands, demographic changes, etc. It can perform modeling of historical demand and volatility on store-SKU (“Stock-keeping unit”) level. The data modeling module's modeling functionality can be based on at least one of the following: foot traffic, price sensitivity, promotions, seasonality, product substitution, competitors products, competitor advertisements, competitor pricing, local activities, holiday calendar, newly opened stores and/or newly introduced products, as well as any other factors.

An output of the data modeling module 106 can be provided to the demand forecasting module 108, as shown in FIG. 1. The demand forecasting module 108 can utilize functional forms and parameter estimates that can be developed by the data modeling module 106 for forecasting of future demand for item(s), item shipments, potential returns, etc. Due to highly dynamic nature of the demand and underlying characteristics of the business environment forward forecasts can include short time horizons (e.g., days, weeks, months, etc.) and can allow for a predetermined level of demand forecasts for sales and/or volatility. The predetermined level can include daily basis, sub-daily basis (e.g., a portion of a day), hourly basis, on a per-minute basis, a predetermined period of time basis, and/or on any other basis and/or any combination thereof.

An output of the demand forecasting module 108 can be passed to the optimization module 110. The optimization module 110 can utilize forecasts and models for building optimized shipment orders developed by the demand forecasting module 108 that can used for management of production schedules, supply chain, and CRM. The optimization module 110 can operate based on a variety of business constraints/rules and can produce optimal scenarios that can be utilized for review of alternatives and “what-if” scenarios.

Referring back to FIG. 2, the system 100 can provide business strategies constraints 202 that can be received as input data to create business rules 212 or otherwise applied to existing business rules 212. Business rules 212 can be used in developing optimization algorithms for the purposes of determining demand, supply, returns, shortages, etc. with regard to items that are being shipped to the location 304. Business rules 212 can also be determined based on KPI library and target information 204 that can be also received as input data and/or the business rules 212 can be applied to the received KPI library and target information 204. An exemplary business rule 212 can provide for shipment of items and/or a number of items and/or at a particular price. Business rules 212 can be also triggered by an occurrence of an event (e.g., natural disaster, man-made disaster, etc.).

The transactional history information 206, master data hierarchies 208 and external data 210 can be validated, cleaned and/or pre-processed, at module 104, prior to being provided to data mining, modeling, and forecasting algorithms 218. The algorithms 218 can use KPI library and targets data 204 as well as any model tuning, configuration, and/or monitoring 214, which can be automatically performed or otherwise manually performed by a user 230. Output of algorithms 218 can be provided along with business rules 212 to optimization algorithms 216 as well as for the purposes of running a simulation 224. The optimization algorithms 216 can determine a particular shipment strategy for a particular item to a particular location 304. The strategy can minimize return/waste as well as maximize revenue along with keeping appropriate levels of inventory at the location 304. The simulation 224 can be ran based on the output of algorithms 218 as well as inputs from the user 230, which can include “what if” scenarios 222. The “what-if” scenarios 222 can be provided by the user to illustrate how the system can behave (e.g., adjust shipment strategy, such as by increasing number of items being shipped to the location 304) when a predetermined event occur (e.g., natural disaster, man-made disaster, etc.). Output of the optimization algorithms 216 and simulation 224 can be presented in a report 220 and/or can be provided to a user's device 240 (e.g., a telephone, a personal computer, a smartphone, a printer, etc.). In the report, the system 100 can recommend various shipment strategies based on the input data presented, account for various events, etc.

In some implementations, order optimization can take into account probability of “Out of Stock” in combination with the “Safety Stock” as control parameters that ensure no additional out of stock is produced on a global level (and/or any specified level of product-store hierarchy) and/or, alternatively, that global aggregated value for out-of-stock can be minimized. It can also provide an opportunity to focus on reduction of “Out of Stock” in addition to order optimization. The system 100 can plan and optimize an order based on a statistical modeling and forecasting of consumer demand on “product-store-day” level (and/or sub-daily level (e.g., a portion of a day), hourly level, a predetermined period of time level, and/or on any other level and/or any combination thereof) that can provide an expected value of units to be sold as well as a variance (volatility) value that can be associated with the forecast of consumer demand. It can be also based on a value of demand and variance in combination with inventory (i.e., “safety stock”) numbers that can provide probabilistic values for an “Out of Stock” event to happen as a function of shipment values. In some implementations, shipping more units can increase “Safety Stock” and reduce probability of an “Out of Stock” events. The system 100 can also use forecasted demand and variance parameters to forecast forward expected safety stock on product-store-day level and optimize orders (i.e., shipments) so that they can satisfy an expected consumer demand and maintain a safety stock on a product-store level.

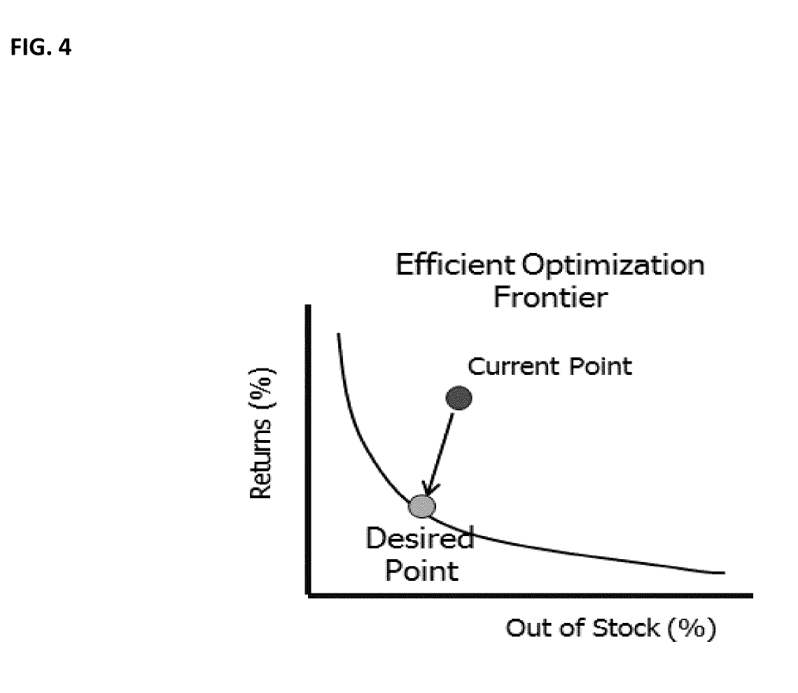

In some implementations, “Safety Stocks” and/or probability of “Out of Stock” event can be control parameters for the purposes of optimization. As shown in FIG. 4, for example, assuming that the “current point” of business is 10% “Out of Stock” and 12% returns on average. Assume that a probability of an “Out of Stock” event can be 10% across all products-stores, which can be close to historical average. The optimization algorithm can adjust values of “Safety Stock” and optimal shipments to have expected “Out of Stock” events at 10%. This means that on average occurrence of an “Out of Stock” event can be at 10% but returns can be reduced from Current Point value of 12% to optimal value of 7% based on product-store level modeling and optimization. If higher or lower values for an occurrence of an “Out of Stock” event exist additional optimal scenarios can be generated to accommodate such values.

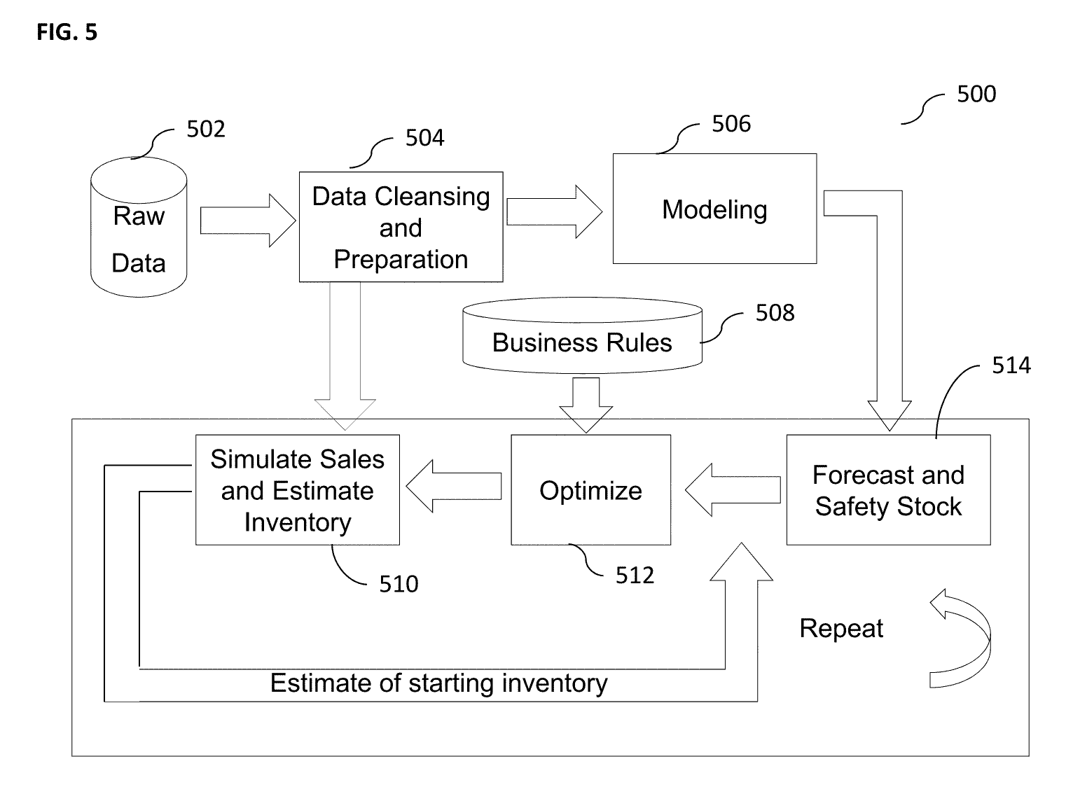

FIG. 5 illustrates an exemplary process 500 for order planning and estimation, according to some implementations of the current subject matter. At 502, a raw data is received. At 504, the raw data is cleaned and prepared for the purposes of modeling and simulation. When preparing data, the system can obtain data (e.g., historical, current, etc.) for a predetermined period of time (e.g., per week, per month, for a predetermined number of days). During such period of time, at least one of the following exemplary data can be obtained by the system 100: data concerning shipped items, returns, expiration dates, location, etc. for each predetermined time interval (e.g., a day) during such period of time, shipment days (e.g., when a shipment may occur), shipments data (e.g., data concerning any executed shipments (as can be indicated by an invoice) for a predetermined time interval of optimization as well as any shipments for next predetermined time interval), a returns rule (e.g., data concerning return dates, age of item returned (e.g., any 6 day old packages of product XYZ returned Tuesday to Friday; 4, 5, or 6 day old packages of product XYZ returned on Saturday, no returns on Sunday or Monday)), unit sales data (e.g., unit sales during previous time intervals), and returns data (e.g., data concerning actual returns). Then, for each location 304, allowable delivery days for the items can be determined based on the available data as well as any business rules that can be provided by the location 304 as well as the distributor 302 (e.g., delivery allowed between Tuesday and Saturday (before September 1) and delivery allowed between Monday and Saturday (after September 1), etc.). Further, for each location, returns data can be gathered to determine that returns of items can be allowed for any item based on a predetermined schedule (e.g., valid delivery days for the location 304 and/or whether such valid delivery day satisfies at least one business rule (e.g., items with shelf life between 5 and 7: stay on the shelf for 4 days only and returned on the 5th day (not allowed to sell on 5th day); items with shelf life 8 or 9: stay on the shelf for 6 days and returned on the 7th day (not allowed to sell on 7th day); if a product has to be returned on day X and there is no pick-up allowed on day X then: return the product on day X-1).

Once the data is prepared and/or preprocessed, at 504, it can be used to generate demand models, at 506. During demand modeling, accuracy, seasonal behavior, behavior during a predetermined period of time (e.g., weekly, monthly, daily, sub-daily, hourly, etc.) can be determined. The output of the modeling 506 can be used for forecasting and “Safety Stock” determination, at 514. Forecast and “Safety Stock” 514 along with business rules 508 can be used to perform order optimization, at 512. Order optimization can seek to minimize returns of an item and to determine an optimal amount of the item to be shipped to the location 304. Such determination can be based on at least one of the following: delivery of an item that is less than a predetermined percentage of a demand during a particular time interval for a predetermined period of time (e.g., less than X % of weekly demand on any given day), no delivery changes during a predetermined time interval (e.g., for the first 2 days), maintain safety stock level, return only on allowable dates, order only on allowable dates, respect tray size constraint, keep an estimate of age of inventory, as well as any other factors.

The optimized strategy determined at 512 along with data processed at 504 can be used to generate order simulations and estimate inventory by age group of an item at the location 304, at 510. This simulation can be used to determine a delivery start date. The processes of forecasting (at 514), optimization (at 512) and simulation (at 510) can be repeated for a predetermined period of time to obtain a correct understanding of the behavior at the location 304, e.g., how many items are being shipped, sold, returned, expire on the shelf, when shipments and/or returns are made, etc.

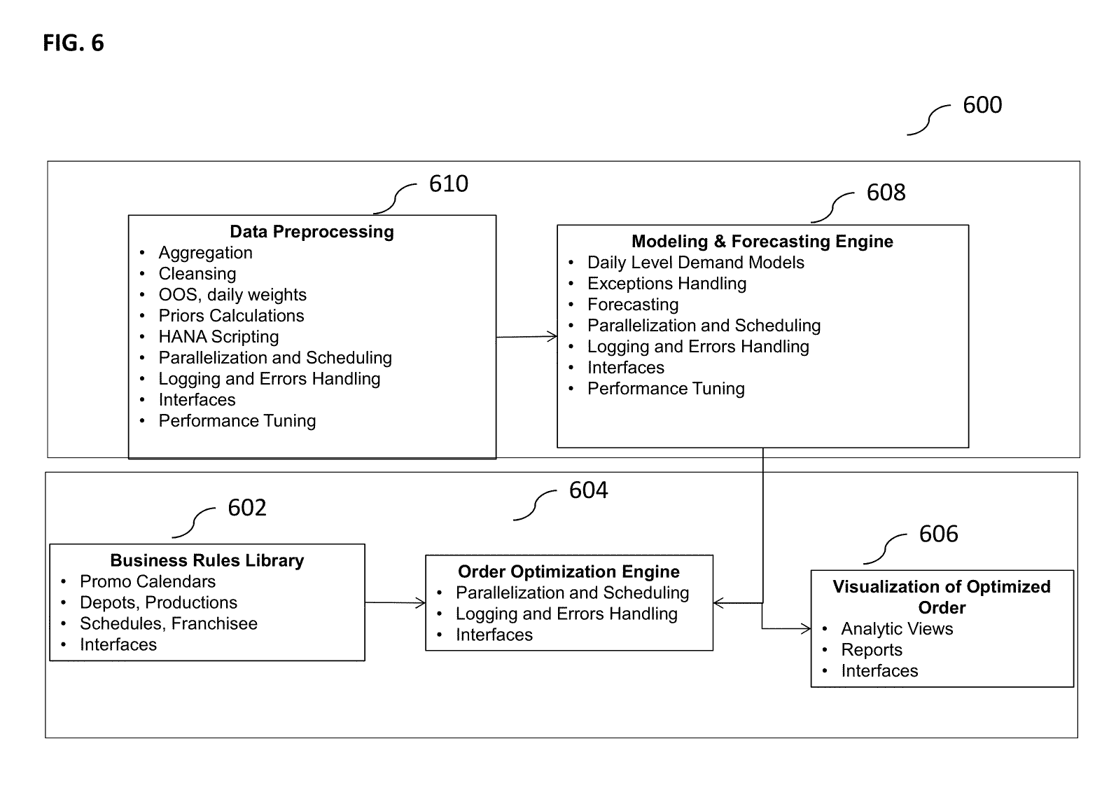

FIG. 6 illustrates an exemplary system 600 for order planning and optimization, according to some implementations of the current subject matter. The system 600 can include a business rules library component 602, an order optimization engine component 604, a visualization of optimized order component 606, a modeling and forecasting engine component 608, and a data preprocessing component 610. The component 602 can include data concerning business rules about at least one of the following: promotional calendars, depots, productions, schedules, franchisee information, and/or provide appropriate user interfaces. The component 604 can provide parallel processing, scheduling, performance tuning, logging and/or error handling, and/or provide appropriate user interfaces that can use the data provided by the business process library. The optimization engine component 604 can also use data provided to it by the modeling and forecasting engine component 608.

The modeling and forecasting engine 608 can generate daily level demand models (and/or sub-daily (e.g., a portion of a day), hourly, on a per-minute, a predetermined period of time, and/or any combination thereof), perform exceptions handling, develop forecasts, perform parallel processing and scheduling, log and handle errors, tune performances, and/or provide appropriate user interfaces. The engine 608 can receive data from the data preprocessing component 610. The data preprocessing component 610 can perform data aggregation, cleansing, process “Out of Stock” events, perform various scripting (e.g., High Performance Analytic Appliance (“HANA”) scripting), perform parallel processing and scheduling, log and handle errors, tune performances, and/or provide appropriate user interfaces.

The component 606 can provide various analytic views, reports, and/or appropriate user interfaces as result of activities by the components 602, 604, 610, and/or 612.

In some implementations, the modeling can be performed using items' freshness that can be based on historical data and optimization of items' shelf life, which, in turn, can be based on intra-day foot traffic and customer-centric demand calculations. The current subject matter system can perform assessment, modeling, simulation, and forecasting of consumer behavior (e.g., normal purchasing pattern, unusual purchasing pattern, idiosyncrasies, etc.) when selecting/purchasing items at the particular location 304 (e.g., a grocery store). In performing these functionalities, the current subject, in addition to considering the factors discussed above, can also account for specific shelf life of a particular product (e.g., short shelf life (e.g., bread, milk, etc., long shelf life (e.g., canned goods, dry goods, etc.)), which can be indicated by an expiration date that can be placed on that product. When it comes to specific shelf life of product, some consumers can be tempted to select and purchase the freshest available product (e.g., with an expiration date that is further away from the date of purchase), others can be indifferent to the expiration date and can select a product without any regard for expiration date, yet other consumers may specifically select a product for purchasing with an expiration date that is closest to the date of purchase, such as to obtain a further discount on the product from the store selling that product. Further, the store when selling its products can have certain policies (which can be part of its business rules) when it comes to stocking its shelves with products. Some stores can request its employees to place the freshest products (i.e., with longer expiration dates) in the back of the shelves while products that are less fresh (i.e., with shorter expiration date) are placed in the front of the shelves. Other stores can request that their employees mix shelf placement locations (e.g., front, back, middle, etc.) of the freshest products and those are less fresh. Further, the stores can also request that their employees perform shelf restocking and/or shelf reshuffling (e.g., moving freshest items to the front of the shelf) at a particular time (e.g., particular day, time of day, etc.). Such activities, whether they take place during intra-day, intra-week, and/or any other time period, as well as level of foot traffic in the store, consumer preferences, and/or any other activities as discussed above, can be modeled to determine a demand for a particular product. An example of such activity can be that during Wednesday morning's foot traffic in the store, 40% non-sensitive to expiration date and 60% sensitive to expiration date customers will appear in the store. For afternoon foot traffic and/or evening foot traffic, such consumer activity can be different. Other days can have a varying activity as well. The foot traffic activity can vary based on alternative days of the week, seasons, promotions, special events, etc.

The above discussed information can be used to perform estimation, modeling, simulation, and forecasting of inventory of at least one product in the store by the mix of the freshness and/or age groups of the items on the shelves in the store. As a result, returns of products can be minimized (by focusing on quicker selling of older items) and freshness mix of the products on the shelves can be improved (by adjusting time and size of fresh deliverables and shelves restocking patterns).

Further, as discussed above, the estimation, modeling, simulation, and forecasting can be based on various data, which can include at least one of the following: product shipment information, unit sales, inventory, and/or returns, as well as any other information. These data components can be interrelated through their governing stochastic dynamics of a sales/replenishment system. Moreover, although the observed values of unit sales and returns have no age information, shipment data can have a deterministic age value (e.g., age=0) and returns data can follow some business-rule based bounds, in addition to the dynamic relationship with shipments, inventory, and unit sales. The age of the items at any given time for either one of these quantities can be a stochastic function of the other quantities. An optimization of this information can implement a use of a particular fit metric (e.g., maximum likelihood method, error minimization methodology, etc.), where at least one combination of the following information can be used: expiration date of a product, consumer product-selection behavior, and/or dynamics of the store product replenishment system. Based on the optimization, an estimation of the age profile of unit sales and the age profile of returns can be determined. Using the age profile of returns and unit sales, an estimate of the inventory can be obtained.

Inventory estimation can allow a determination of how many units a location has in the inventory as well as age(s) of product(s) as well as a probability distribution for the product(s). Additionally, a model for customer purchasing preference(s) at the item age level can be determined. For example, a probability distribution of how consumers select products based on the available inventory can be determined. Further, unit sales age can be estimated as well. This means that a determination can be made as to the age of each unit out of U units that were sold on day D. A determination can be made as to a probability distribution for unit sales over age and time. Also, return age of product(s) can be determined. This means that a determination can be made as to the age of each unit out of R units that were returned on day D. Similarly, a determination can be made as to a probability distribution for returns over age and time. A unit can be a particular product or a batch of products (e.g., a container, a daily shipment, a weekly shipment, etc.), where products can be the same or different.

The current subject matter can perform the above operations quickly (e.g., hourly, daily, overnight, weekly, or at any predetermined time period), where the operations can be performed at the particular location, for a particular product, for a particular age level, and/or for a large number of products, stores, locations, etc. Once the above relationships are estimated, an optimization algorithm can be performed to minimize returns, maximize profits, sales, and/or any combination thereof, based on a forecasted demand for the product(s).

In some implementations, the current subject matter can be implemented in various in-memory database systems that can require its users to have authorization profiles for the purposes of accessing data in such systems. As stated above, an example of such in-memory database systems includes High Performance Analytic Appliance (“HANA”) system as developed by SAP AG, Walldorf, Germany. Various systems, such as, enterprise resource planning (“ERP”) system, supply chain management system (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

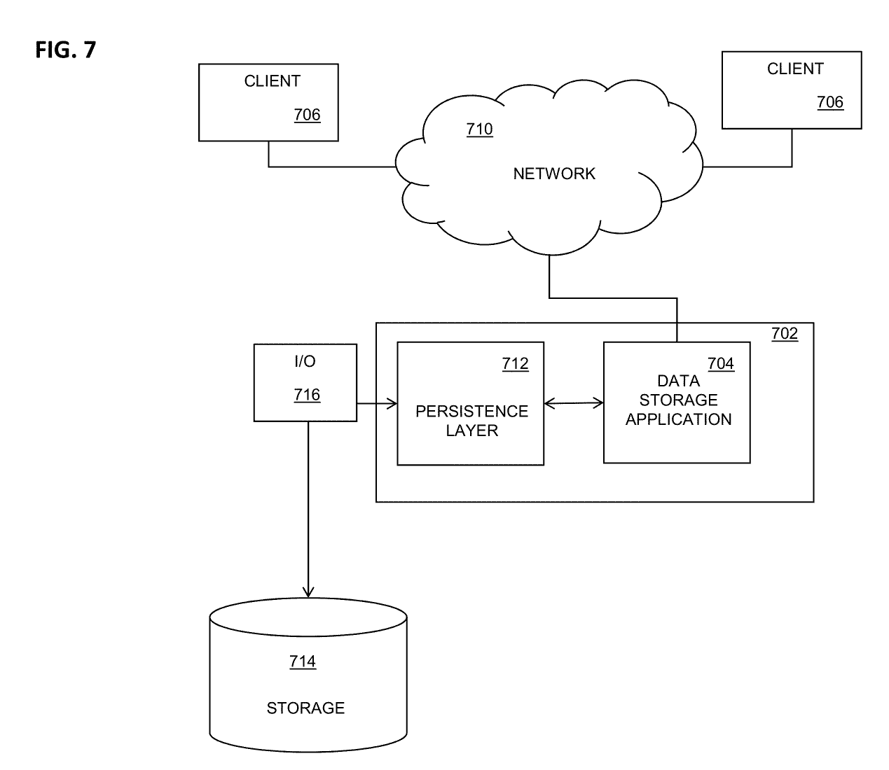

FIG. 7 illustrates an exemplary system 700 in which a computing system 702, which can include one or more programmable processors that can be collocated, linked over one or more networks, etc., executes one or more modules, software components, or the like of a data storage application 704, according to some implementations of the current subject matter. The data storage application 704 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 702 as well as to remote users accessing the computing system 702 from one or more client machines 706 over a network connection 710. One or more user interface screens produced by the one or more first modules can be displayed to a user, either via a local display or via a display associated with one of the client machines 706. Data units of the data storage application 704 can be transiently stored in a persistence layer 712 (e.g., a page buffer or other type of temporary persistency layer), which can write the data, in the form of storage pages, to one or more storages 714, for example via an input/output component 716. The one or more storages 714 can include one or more physical storage media or devices (e.g. hard disk drives, persistent flash memory, random access memory, optical media, magnetic media, and the like) configured for writing data for longer term storage. It should be noted that the storage 714 and the input/output component 716 can be included in the computing system 702 despite their being shown as external to the computing system 702 in FIG. 7.

Data retained at the longer term storage 714 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

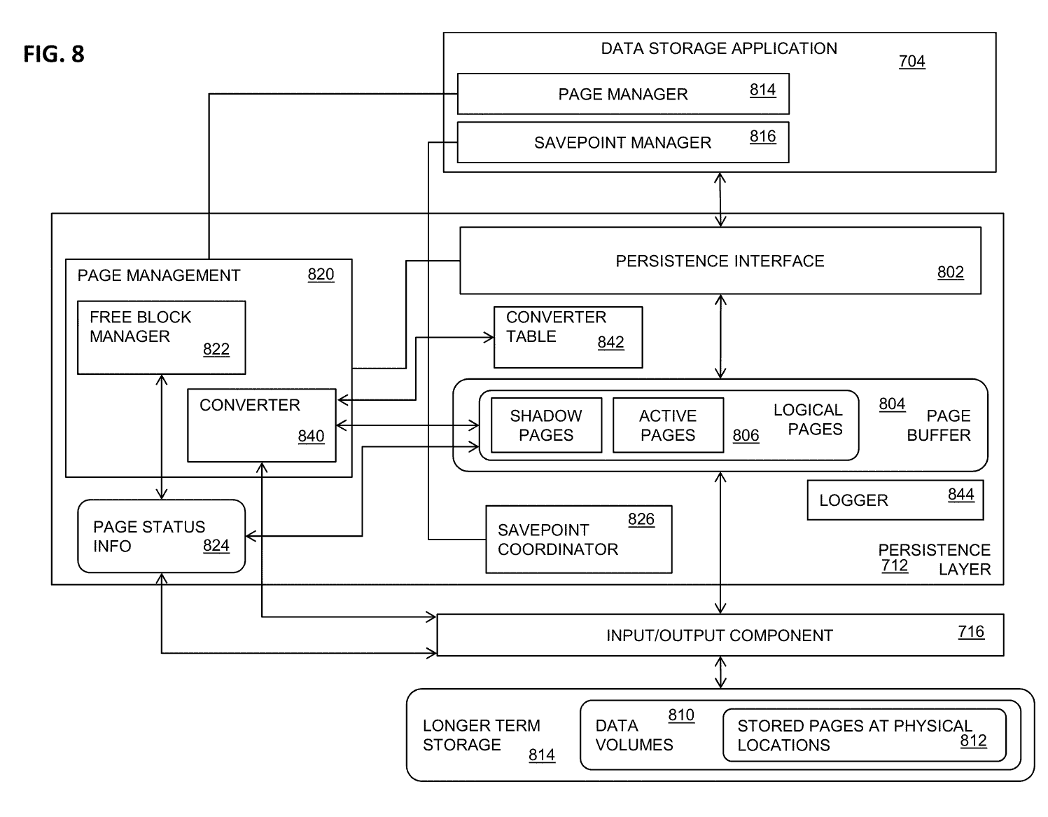

FIG. 8 illustrates an exemplary software architecture 800, according to some implementations of the current subject matter. A data storage application 704, which can be implemented in one or more of hardware and software, can include one or more of a database application, a network-attached storage system, or the like. According to at least some implementations of the current subject matter, such a data storage application 704 can include or otherwise interface with a persistence layer 712 or other type of memory buffer, for example via a persistence interface 802. A page buffer 804 within the persistence layer 712 can store one or more logical pages 806, and optionally can include shadow pages, active pages, and the like. The logical pages 806 retained in the persistence layer 712 can be written to a storage (e.g. a longer term storage, etc.) 714 via an input/output component 716, which can be a software module, a sub-system implemented in one or more of software and hardware, or the like. The storage 714 can include one or more data volumes 810 where stored pages 812 are allocated at physical memory blocks.

In some implementations, the data storage application 704 can include or be otherwise in communication with a page manager 814 and/or a savepoint manager 816. The page manager 814 can communicate with a page management module 820 at the persistence layer 712 that can include a free block manager 822 that monitors page status information 824, for example the status of physical pages within the storage 714 and logical pages in the persistence layer 712 (and optionally in the page buffer 804). The savepoint manager 816 can communicate with a savepoint coordinator 826 at the persistence layer 712 to handle savepoints, which are used to create a consistent persistent state of the database for restart after a possible crash.

In some implementations of a data storage application 704, the page management module of the persistence layer 712 can implement a shadow paging. The free block manager 822 within the page management module 820 can maintain the status of physical pages. The page buffer 804 can include a fixed page status buffer that operates as discussed herein. A converter component 840, which can be part of or in communication with the page management module 820, can be responsible for mapping between logical and physical pages written to the storage 714. The converter 840 can maintain the current mapping of logical pages to the corresponding physical pages in a converter table 842. The converter 840 can maintain a current mapping of logical pages 806 to the corresponding physical pages in one or more converter tables 842. When a logical page 806 is read from storage 714, the storage page to be loaded can be looked up from the one or more converter tables 842 using the converter 840. When a logical page is written to storage 714 the first time after a savepoint, a new free physical page is assigned to the logical page. The free block manager 822 marks the new physical page as “used” and the new mapping is stored in the one or more converter tables 842.

The persistence layer 712 can ensure that changes made in the data storage application 704 are durable and that the data storage application 704 can be restored to a most recent committed state after a restart. Writing data to the storage 714 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 844 can also be included to store the changes made to the data of the data storage application in a linear log. The logger component 844 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 844 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 712 can use a combination of undo log entries (from one or more logs) and shadow paging.

The persistence interface 802 can handle read and write requests of stores (e.g., in-memory stores, etc.). The persistence interface 802 can also provide write methods for writing data both with logging and without logging. If the logged write operations are used, the persistence interface 802 invokes the logger 844. In addition, the logger 844 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 844. For an entry of type “update”, for example, this would be the identification of the affected record and the after image of the modified data.

When the data application 704 is restarted, the log entries need to be processed. To speed up this process the redo log is not always processed from the beginning Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 844 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 844 can write a database log(or simply referred to herein as a “log”) sequentially into a memory buffer in natural order (e.g., sequential order, etc.). If several physical hard disks/storage devices are used to store log data, several log partitions can be defined. Thereafter, the logger 844 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 704 can use shadow paging so that the savepoint manager 816 can write a transactionally-consistent savepoint. With such an arrangement, a data backup comprises a copy of all data pages contained in a particular savepoint, which was done as the first step of the data backup process. The current subject matter can be also applied to other types of data page storage.

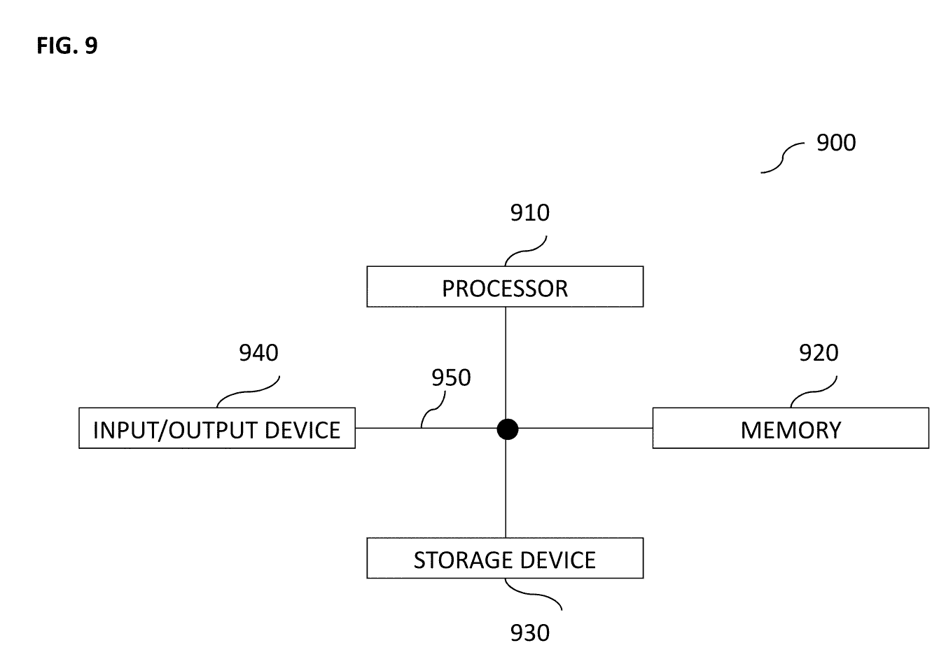

In some implementations, the current subject matter can be configured to be implemented in a system 900, as shown in FIG. 9. The system 900 can include a processor 910, a memory 920, a storage device 930, and an input/output device 940. Each of the components 910, 920, 930 and 940 can be interconnected using a system bus 950. The processor 910 can be configured to process instructions for execution within the system 900. In some implementations, the processor 910 can be a single-threaded processor. In alternate implementations, the processor 910 can be a multi-threaded processor. The processor 910 can be further configured to process instructions stored in the memory 920 or on the storage device 930, including receiving or sending information through the input/output device 940. The memory 920 can store information within the system 900. In some implementations, the memory 920 can be a computer-readable medium. In alternate implementations, the memory 920 can be a volatile memory unit. In yet some implementations, the memory 920 can be a non-volatile memory unit. The storage device 930 can be capable of providing mass storage for the system 900. In some implementations, the storage device 930 can be a computer-readable medium. In alternate implementations, the storage device 930 can be a floppy disk device, a hard disk device, an optical disk device, a tape device, non-volatile solid state memory, or any other type of storage device. The input/output device 940 can be configured to provide input/output operations for the system 900. In some implementations, the input/output device 940 can include a keyboard and/or pointing device. In alternate implementations, the input/output device 940 can include a display unit for displaying graphical user interfaces.

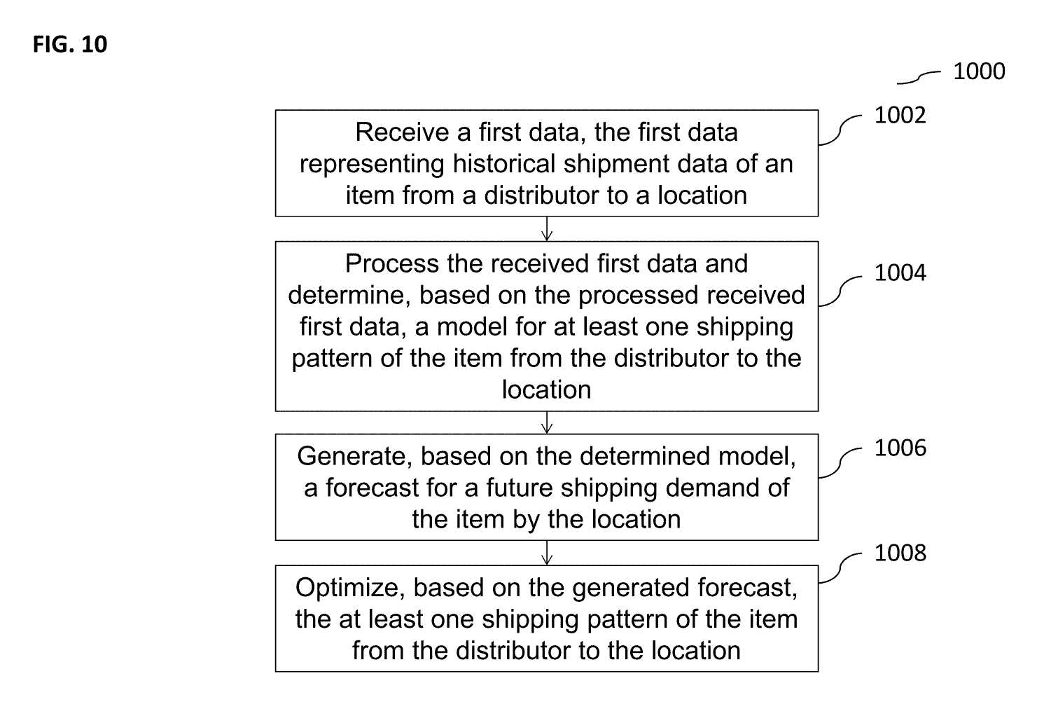

FIG. 10 illustrates an exemplary method 1000, according to some implementations of the current subject matter. At 1002, a first data representing historical shipment data of an item from a distributor to a location can be received. At 1004, the received first data can be processed and, based on the processed received first data, a model for at least one shipping pattern of the item from the distributor to the location can be determined. At 1006, a forecast for a future shipping demand of the item by the location can be generated based on the determined model. At 1008, at least one shipping pattern of the item from the distributor to the location can be optimized based on the generated forecast. At least one of the receiving, the processing, the determining, the generating, and the optimizing can be performed on at least one processor.

The current subject matter can include at least one of the following optional features. The first data can include at least one of the following: a foot traffic at the location, a historical point-of-sale data of the item, including promotional activities, an inventory of the item at the location, a competitor of the location information with regard to the item, a return data representing returns of the item from the location, at least one calendar at the location, and at least one business rule concerning shipment of the item from the distributor to the location. Models can be determined based on the above mentioned data and allow the creation of estimates of at least one of the following: price sensitivity of the item at the location, promotional effect with regard to the item as determined at the location, a seasonality of the item at the location, age of the item at the location, customer purchasing pattern with regard to the item, age of the returned items from the location, and a substitution policy of the item at the location. The forecast can be generated for a predetermined period of time. The optimizing of the at least one shipping pattern of the item can include optimizing the at least one shipping pattern based on at least one unforeseen event.

The future shipping demand can be determined based on a simulation of at least one sale of the item at the location. The method can further include determining, based on the simulation, a starting date for shipping of the item to the location.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
receiving a first data, the first data representing historical shipment data of an item from a distributor to a location;
processing the received first data and determining, based on the processed received first data, a model for at least one shipping pattern of the item from the distributor to the location;
generating, based on the determined model, a forecast for a future shipping demand of the item by the location; and
optimizing, based on the generated forecast, the at least one shipping pattern of the item from the distributor to the location, the at least one shipping pattern optimized based on a plurality of control parameters including at least an out of stock event probability and a safety stock value, the optimizing performed using the plurality of control parameters for the item at the location during a predetermined period of time,
wherein the receiving, the processing, the determining, the generating, and the optimizing are performed on at least one processor.

2. The method according to claim 1, wherein the first data includes at least one of the following: a historical point-of-sale data of the item, an inventory of the item at the location, a return data representing returns of the item from the location, and at least one business rule concerning shipment of the item from the distributor to the location.

3. The method according to claim 1, wherein the model is determined based on at least one of the following: a foot traffic at the location, price sensitivity of the item at the location, at least one promotion with regard to the item as determined at the location, a seasonality of the item at the location, a substitution policy of the item at the location, a competitor of the location information with regard to the item, and at least one calendar at the location.

4. The method according to claim 1, wherein the forecast is generated for a predetermined period of time.

5. The method according to claim 1, wherein the optimizing of the at least one shipping pattern of the item further comprises optimizing the at least one shipping pattern based on at least one unforeseen event.

6. The method according to claim 1, wherein the future shipping demand is determined based on a simulation of at least one sale of the item at the location.

7. The method according to claim 6, further comprising:
determining, based on the simulation, a starting date for shipping of the item to the location.

8. A computer program product comprising a non-transitory machine-readable medium storing instructions that, when executed by at least one programmable processor, cause the at least one programmable processor to perform operations comprising:
receiving a first data, the first data representing historical shipment data of an item from a distributor to a location;
processing the received first data and determining, based on the processed received first data, a model for at least one shipping pattern of the item from the distributor to the location;
generating, based on the determined model, a forecast for a future shipping demand of the item by the location; and
optimizing, based on the generated forecast, the at least one shipping pattern of the item from the distributor to the location, the at least one shipping pattern optimized based on a plurality of control parameters including at least an out of stock event probability and a safety stock value, the optimizing performed using the plurality of control parameters for the item at the location during a predetermined period of time.

9. The computer program product according to claim 8, wherein the first data includes at least one of the following: a historical point-of-sale data of the item, an inventory of the item at the location, a customer purchasing pattern with regard to the item, a return data representing returns of the item from the location, and at least one business rule concerning shipment of the item from the distributor to the location.

10. The computer program product according to claim 8, wherein the model is determined based on at least one of the following: a foot traffic at the location, price sensitivity of the item at the location, at least one promotion with regard to the item as determined at the location, a seasonality of the item at the location, a substitution policy of the item at the location, a competitor of the location information with regard to the item, and at least one calendar at the location.

11. The computer program product according to claim 8, wherein the forecast is generated for a predetermined period of time.

12. The computer program product according to claim 8, wherein the optimizing of the at least one shipping pattern of the item further comprises optimizing the at least one shipping pattern based on at least one unforeseen event.

13. The computer program product according to claim 8, wherein the future shipping demand is determined based on a simulation of at least one sale of the item at the location.

14. The computer program product according to claim 13, wherein the operations further comprise:
determining, based on the simulation, a starting date for shipping of the item to the location.

15. A system comprising:
at least one programmable processor; and
a machine-readable medium storing instructions that, when executed by the at least one programmable processor, cause the at least one programmable processor to perform operations comprising:
receiving a first data, the first data representing historical shipment data of an item from a distributor to a location;
processing the received first data and determining, based on the processed received first data, a model for at least one shipping pattern of the item from the distributor to the location;
generating, based on the determined model, a forecast for a future shipping demand of the item by the location; and
optimizing, based on the generated forecast, the at least one shipping pattern of the item from the distributor to the location, the at least one shipping pattern optimized based on a plurality of control parameters including at least an out of stock event probability and a safety stock value, the optimizing performed using the plurality of control parameters for the item at the location during a predetermined period of time.

16. The system according to claim 15, wherein the first data includes at least one of the following: a historical point-of-sale data of the item, an inventory of the item at the location, a customer purchasing pattern with regard to the item, a return data representing returns of the item from the location, and at least one business rule concerning shipment of the item from the distributor to the location.

17. The system according to claim 15, wherein the model is determined based on at least one of the following: a foot traffic at the location, price sensitivity of the item at the location, at least one promotion with regard to the item as determined at the location, a seasonality of the item at the location, a substitution policy of the item at the location, a competitor of the location information with regard to the item, and at least one calendar at the location.

18. The system according to claim 15, wherein the forecast is generated for a predetermined period of time.

19. The system according to claim 15, wherein the optimizing of the at least one shipping pattern of the item further comprises optimizing the at least one shipping pattern based on at least one unforeseen event.

20. The system according to claim 15, wherein the future shipping demand is determined based on a simulation of at least one sale of the item at the location, and
wherein a starting date for shipping of the item to the location is determined based on the simulation.
